(19) United States
(12) Patent Application Publication
(10) Pub. No.: US 2007/0036377 A1
(43) Pub. Date: Feb. 15, 2007

(54) Method of obtaining a characteristic, and hearing instrument

(76) Inventor: Alfred Stirnemann, Zollikon (CH)

Correspondence Address: PEARNE & GORDON LLP, 1801 EAST 9TH STREET, SUITE 1200, CLEVELAND, OH, 44114-3108, US

(21) Appl. No.: 11/196,115

(22) Filed: Aug. 3, 2005

(51) Int. Cl. H04R 25/00

(52) U.S. Cl. 381/315

(57) ABSTRACT

According to the invention, a hearing instrument comprising at least one inner microphone operable to determine a sensing signal representative of an acoustic signal at a position in front of the user's eardrum—which may be an acoustic signal at a position between an ITE (or ITC or CIC) hearing instrument and the eardrum or between an earpiece and the eardrum—is used. In accordance with the invention, in front of the eardrum an acoustic signal is produced. The inner microphone creates a sensing signal representative of the acoustic signal, and the signal processing unit of the hearing instrument determines a characteristic of the user's ear canal based thereon and memorizes values indicative of the characteristic. According to a preferred embodiment, the characteristic is an acoustic coupling transfer characteristic, which is determined based on a comparison of a signal representative of the output signal of the signal processing unit's digital signal processing stage and the sensing signal. In contrast to the state of the art, no control loop is necessary to adapt the gain to the ear canal characteristic, but the memorized values may be used therefor.

### FIELD OF THE INVENTION

The invention is in the field of hearing instruments. It more particularly relates to a method of obtaining a characteristic of acoustical circumstances in an ear canal of a user, to a hearing instrument, and to a method of fabricating a hearing instrument.

### BACKGROUND OF THE INVENTION

The acoustical output of a hearing instrument as perceived by the user depends on the environment of the hearing instrument, especially on the ear canal properties. Conventionally, for modeling the effective gain provided by a hearing instrument placed in an ear canal, measurements in a so-called “2 cc coupler” are used. However, this model system merely provides an influence of an average ear canal on the effective gain provided by a hearing instrument. The accuracy of such a model system is limited. The difference between the signal level in the real ear and the level in the 2 cc coupler is often called “Real Ear to Coupler Difference” RECD.

As a consequence, when hearing instruments are set up in accordance with the needs of a user, the problem of the uncertain RECD given the individual ear canal parameters arises. The different ear canal geometries and ear canal textures of individuals' ear canals, conchas and neighboring tissues and organs (leading to individual ear impedances) as well as uncertainties concerning the vent geometry, leakage, hook damping and individual tubing give rise to different signal transfer characteristic even if the gain of the hearing instruments is the same.

The state of the art contains different approaches for addressing this problem. Swiss patent 678'692 teaches to place a microphone in the user's ear canal in order to measure acoustical properties. The results are analyzed by a specific device (audiometer). According to the teachings of U.S. Pat. No. 4,596,902 and U.S. Pat. No. 6,658,122 the hearing device comprises a microphone operable to measure the acoustic pressure in the ear canal and a control circuit for real-time adjustment of the gain characteristic if the measured acoustic pressure does not correspond to a reference acoustic pressure. Such a feedback control, however, uses up a lot of calculation power.

### SUMMARY OF THE INVENTION

It is an object of the invention to provide a method of operating a hearing instrument, a hearing instrument, and a method of manufacturing a hearing instrument which address the problem of uncertain coupling of the hearing instrument to the individual ear of a user and which overcome drawbacks of prior art approaches and especially do not require too much calculation power to be used.

In accordance with the invention, a method of obtaining a characteristic of acoustical circumstances in an ear canal of a user is provided, in which a hearing instrument or a hearing instrument component is placed, the hearing instrument including at least one outer microphone, a signal processing unit, at least one receiver, and at least one inner microphone operable to obtain a sensing signal from an acoustic signal at a position in front of the user's eardrum, the method comprising the steps of producing an acoustic signal in at least a part of the ear canal, of obtaining, by means of said inner microphone, a sensing signal representative of said acoustic signal, of determining, by said signal processing unit and from said sensing signal, a characteristic of the acoustical circumstances, and of memorizing values indicative of said characteristic for further use.

Further, a hearing instrument is provided, the hearing instrument comprising an in-the-ear component adapted to be at least partially placed in the ear canal of a user, the hearing instrument further comprising at least one outer microphone, a signal processing unit comprising a data memory, and at least one receiver, the signal processing unit being operable to transform an input signal provided by said at least one outer microphone into an output signal supplied to said at least one receiver, the hearing instrument further comprising at least one inner microphone operable to obtain a sensing signal from an acoustic signal at a position in front of the user's eardrum, an output of the inner microphone being operatively connected to an input of the signal processing unit, the signal processing unit being operable to obtain from the sensing signal provided by said inner microphone, a characteristic of acoustical circumstances in the user's ear canal, and to memorize, in said data memory, values indicative of said characteristic for further use.

Also, a hearing instrument is provided, the hearing instrument comprising

at least one acoustic signal acquisition microphone,

a signal processing unit,

and at least one receiver, the at least one acoustical signal acquisition microphone being operationally connected to a first input of the signal processing unit,

an output of the signal processing unit being operationally connected to an input of said receiver,

the signal processing unit comprising a digital signal processing stage and a memory,

an output of said digital signal processing stage being operationally connected to said output of the signal processing unit,

the hearing instrument further comprising an in-the-ear canal acoustic signal acquisition microphone, an output of which is operationally connected to a second input of said signal processing unit,

the signal processing unit being operable to apply a gain on an input signal supplied to said first input to obtain an output signal and to supply said output signal to said output,

the signal processing unit further being operable to calculate, based on a comparison of said sensing signal supplied to said second input with an output signal of said digital signal processing stage, a transfer characteristic, and to apply a gain adjustment on said gain, the gain adjustment based on said transfer characteristic,

wherein at least one of the transfer characteristic and of the gain adjustment is stored in the memory, and wherein the same transfer characteristic is used for determining a gain adjustment for a plurality of gain calculation cycles or wherein the same gain adjustment is applied to the gain for a plurality of gain calculation cycles (or sampling cycles; the time interval during which a same gain adjustment is applied corresponds to a plurality of sampling intervals).

Even further, a method of manufacturing a hearing instrument is provided, the method comprising the steps of
assembling at least one outer microphone, a signal processing unit, at least one receiver and at least one inner microphone, the inner microphone forming part of an in-the-ear component or comprising sound conducting tubing connecting it to the in-the-ear component, the signal processing unit comprising a data memory,
of establishing operational connections between an output of the at least one outer microphone and the signal processing unit, between an output of the signal processing unit and an input of the at least one receiver, and between an output of the at least one inner microphone and a further input of the signal processing unit,
   and of providing the signal processing unit with a software enabling the signal processing unit to obtain from a sensing signal provided by said inner microphone, a characteristic of acoustical circumstances in the user's ear canal, and to memorize, in the data memory, values indicative of said characteristic for further use.

According to the invention, therefore, a hearing instrument comprising at least one microphone operable to determine a sensing signal representative of an acoustic signal at a place in front of the user's eardrum is used. In the case of a hearing instrument including multiple components (such as a hearing instrument comprising an in-the-ear (ITE) component (earpiece) and a behind-the-ear (BTE) component), said microphone may be physically located in the innermost component (earpiece) or may be located elsewhere and connected to the place the signal is collected from. This microphone in this text—independent of its physical location—is called “inner microphone” in contrast to the at least one “outer microphone” which converts the acoustic signal incident on the hearing instrument (or a component thereof) from the outside into an electric signal to be transformed in an output signal. In cases where the inner microphone is not placed at the position from where the acoustic signal is collected, it is connected to the position by sound conducting means. Such means may comprise a sound conducting tube, possibly including cerumen protection and/or a specifically adapted end geometry for ideal sound incoupling. As an alternative, the means may comprise a channel within a housing or other sound conductors.

The acoustic signal may for example be a signal in a closed or not closed volume between an ITE (or ITC or CIC) hearing instrument and the eardrum or a volume between an earpiece of a hearing instrument and the eardrum.

In accordance with the invention, in front of the eardrum, an acoustic signal is produced. The inner microphone creates a sensing signal representative of the acoustic signal, and the signal processing unit of the hearing instrument determines a characteristic of acoustical circumstances in the user's ear canal based thereon and memorizes values indicative of the characteristic.

In this text, a signal processing unit may comprise a single digital signal processor (DSP) possibly including analog-to-digital (A/D) and digital-to-analog (D/A) conversion stages. An analog amplifier may be also integrated or may be provided separately. This includes, as an example, a class D amplifier that is directly fed by a pulse width modulated signal from the signal processing unit and which redundantizes a classical D/A converter. As an alternative, the signal processing unit may comprise two or more communicatively coupled entities, for example a digital signal processor and physically separate A/D and/or D/A converters. It may also comprise a plurality of processors and/or other digital and/or analog signal processing elements. The signal processing unit also comprises a data memory, which is for example integrated in the digital signal processor(s) or in another element or which may be provided as separate data memory. Different elements constituting the signal processing unit do not need to be physically grouped together but may even be distributed between different hearing instrument components.

According to the invention, the hearing instrument's signal processing unit may calculate a characteristic of the ear canal which is used for optimized signal processing, for example for adapting a gain to the individual properties of the ear canal (vent leakage, impedance, etc.). Therefore, on the one hand, a separate device for measuring ear canal characteristic is not necessary, and the user of the hearing instrument does not have to go to the hearing aid professional in order to adapt the hearing instrument to the ear canal characteristic. On the other hand, the approach in accordance with the invention eliminates the need for a control loop—as has been presented in the state of the art—which would use up a lot of calculating power. Also, in contrast to the state of the art, a stored characteristic may not only be used for controlling and correcting the actually perceived signal by way of a gain adjustment but may be used for other purposes as well, including diagnostic purposes, as will be explained in the following.

In accordance with a first aspect of the invention, a transfer characteristic is evaluated by the hearing instrument, i.e. by the digital signal processing (DSP) unit. The transfer characteristic is representative of the acoustic coupling from the processed electric signal, as presented at the DSP output, to the real-ear acoustic signal.

The transfer characteristic may be stored in any way suitable to store a characteristic. Examples of values representative of a transfer function include:
1) the complex values obtained by a Fourier analysis of the transfer function.
2) only the absolute values of the Fourier coefficients.
3) one absolute value for each one of a plurality of frequency bands, such as bark bands, bands in accordance with an other psychoacoustical scale, third octave bands, etc. Such absolute values may for example be obtained by averaging a number of coefficients in accordance with 2).
4) Coefficients of a Finite Impulse Response (FIR) filter approximation of an Infinite Impulse Response (IIR) approximation or similar.
5) impulse responses.
6) complex coefficients of a numerator/denominator polynomial.
7) etc.

The values may for example be stored in the signal processing unit as the RECD values. Storing of RECD values for signal processing has been known in state-of-the-art hearing instruments. In state-of-the-art hearing instruments, however, the RECD values are determined indirectly during a fitting process. One advantage of the first aspect of the invention, therefore, may be to simplify the fitting process.

In accordance with a preferred embodiment of the invention, a signal representative of an output of the digital signal processing stage is compared with the sensing signal in order to obtain the transfer characteristic and to obtain a gain adjustment to the real ear situation.

The digital signal processing stage (DSP) output is the signal after the signal processing steps including hearing loss correction, noise reduction steps, etc. The DSP output may but need not be the physical output of a signal processing ‘chip’.

Rather, often a signal processing chip comprises a digital-to-analog conversion stage or a processing stage transforming the digital signal into a pulse width modulated signal, which stage may be thought of as being arranged downstream of a DSP output.

In a simplified model of the gain relations in a hearing instrument the incident acoustic signal is subject to the following steps to yield the acoustic signal in the user's ear:
Data acquisition→DSP Gain→Outcoupling

The quantity measuring the gain of the data acquisition stage (which gain is governed by the location of the microphones on the hearing instrument and their physical properties) is the input sensitivity SENSIN. The gain of the outcoupling is governed by the output sensitivity of the receiver(s) and the properties of the real ear (impedance, etc.). The output sensitivity SENSOUT of a hearing instrument is usually known for the 2 cc coupler situation. The difference between this known output sensitivity and the real-ear output sensitivity is known as the RECD.

Therefore, for the effective gain (Real Ear Aided Gain, REAG) the following relation holds:
DSP GAIN=REAG−SENSIN−SENSOUT−RECD (1)

If “ACOUSTIC COUPLING” is defined as
ACOUSTIC COUPLING=SENSOUT+RECD (2)
it follows that
DSP GAIN=REAG−SENSIN−ACOUSTIC COUPLING (3)

In equation (1), the individual RECD is the only unknown quantity of the system, since the input sensitivity as well as the output sensitivity on the coupler are known. In the present invention, preferably instead of addressing the RECD, ACOUSTIC COUPLING is quantified.

In modern hearing instruments, the DSP gain is situation dependent. It is influenced by user chosen programs (for example direction sensitive or omnidirectional), environmental conditions (adaptive noise suppression, possibly for special kinds of noise), etc. Therefore, in general the relationship between an input signal and an output signal is non-linear.

It is an insight of the inventor of the present application that, however, the acoustic coupling as part of the pure electro-acoustic system is approximately linear and that it therefore may be viewed as independent of the sound level and as a consequence also independent of the DSP GAIN, which latter may vary dynamically depending on the situation. This means that the acoustic coupling may be characterized by an essentially time independent transfer function T(ƒ), where ƒ denotes the frequency. The transfer function is independent of the DSP gain and at least approximately also of the acoustic signal produced by the receiver, since the DSP-output-to-real-ear-sound-pressure-transfer is at least approximately linear. The spectrum of the signal is cancelled out when the transfer function is measured. It is, therefore, preferred to compare the output of the DSP (i.e. the digital or—less preferred—possibly, if the amplification is load independent, the analog signal after the gain stage) with the sensing signal. In other words, in contrast to the situation in dynamic control circuits, where an input signal or an uncorrected output of the digital signal processor is compared with the acoustic signal in the ear canal, the approach presented here includes using for the comparison a signal which is representative of the electric input signal of the receiver. For example, the signal used for the comparison may be the receiver input signal before Digital-to-Analog conversion and amplification, i.e. a signal at least approximately proportional to the receiver input signal.

It is for this reason that this approach of using the acoustic coupling redundantizes a control circuit dynamically controlling the effective signal level in the ear. It suffices to obtain a transfer characteristic once or repeatedly at intervals which are long compared to the sampling interval and to characteristic sound signal variation time constants. For example in the case of digital signal processing, the rate with which a transfer characteristic is obtained (if the transfer characteristic is obtained regularly at all) is at least 1000, preferably at least 1'000'000 times lower than the signal processing unit's sampling rate. The transfer characteristic may for example be obtained only during the fitting process and/or once every day (when the hearing instrument is switched on), once every hour, upon incidence of certain events (for example initiation by the user, battery replacement, etc.), or the like. In case of regular updates of the transfer characteristic, the interval between updates is for example always greater than 1 s, preferably greater than 1 min. or even greater than 1 h.

The transfer characteristic may, as mentioned above, for example be memorized by way of storing parameters of a transfer function T(f). Alternately, instead of a transfer function, gain correction parameters may be directly stored, so that no explicit calculation of the transfer function T(f) is necessary. The art provides yet further alternatives of characterizing a transfer between a (digital) electric signal and a real-ear acoustic signal, which further alternatives may also be used in accordance with the invention.

Since the transfer from the DSP output to the signal in the ear canal (the acoustic coupling) is linear, it may be characterized by comparing a DSP output representing any acoustic signal with the corresponding real ear acoustic signal. In order to determine the transfer characteristic, an arbitrary acoustic signal may be incident on the hearing instrument at a measuring time. It is not necessary to use a particular signal with a particular frequency characteristic for this. According to an embodiment of the invention, however, the arbitrary input signal may be replaced or supplemented by a special processor generated measuring signal supplied to the receiver. By this, the coherence and thus the quality of the measurement may be improved. The measuring signals may be on a non-audible level and may provide the desired functionality nevertheless due to appropriately longer averaging. Possible suited measuring signals are for example Maximum Length Sequence (MLS) signals, which as such are known in the art and are not described any further here.

The transfer characteristic may be used for adjusting a gain of the hearing instrument, which gain is then specifically adapted to the individual circumstances. Nevertheless, in contrast to control circuit approaches such as the approaches disclosed in U.S. Pat. No. 4,596,902 and U.S. Pat. No. 6,658,122, the adaptation to the individual circumstances does not necessarily cause a lot of computing power to be used. Rather, the same correction parameters may be used during a long period and in largely different circumstances, nevertheless yielding a good and appropriate correction. Also, in contrast to other prior art approaches, the presence of a hearing aid professional and of special equipment is not necessary in order to make this specific adaptation.

Most hearing instruments nowadays comprise at least two input microphones (“outer microphones” in this text) in order to enable beamforming. As a consequence, the hearing instruments also comprise an equal number of Analog-to-Digital (A/D) converters. According to a preferred embodiment of the invention, the inner microphone does not necessitate a further A/D converter. Rather, the hearing instrument comprises a switch by which alternatively the output of one outer microphone and of the inner microphone may be connected to the input of one of the A/D converters. This makes possible, that for occasional measurements of the transfer characteristic, the beamforming functionality is at least partially interrupted, and the characteristic may be measured without interrupting the hearing aid operation and without additional hardware.

A similar approach may be chosen for hearing instruments with only one outer microphone. In such hearing instruments, a single A/D converter input may be alternatively switched between the outer and the inner microphone. For measuring the transfer characteristic, a processor generated signal is used, and the hearing aid operation has to be interrupted. However, this procedure for example only has to be done initially when the hearing instrument is positioned at is operating place and is therefore not even necessarily perceived by the user.

The transfer characteristic may, in addition to influencing the gain characteristic of the signal processing unit or as an alternative thereto, also be used for other purposes.

As a first additional or alternative use, the transfer characteristic may be used for estimating the ear canal transfer function. Even though often in the literature no difference is made between different positions of a microphone placed in the ear canal (of an “inner microphone”) or of an end of a sound conducting means leading thereto, in practice the distance between the microphone and the eardrum is important. In order to address this, a testing probe may be placed close (closer than 5 mm) to the eardrum and used to measure the sound level there. However, this may be done by a hearing aid professional only (due to the danger of damaging the eardrum), brings about additional efforts, and is imprecise due to the influence of the testing probe's finite size on the acoustical circumstances. However, investigations by the inventor have shown that there is a strong relation between the acoustical impedances and the transfer within the ear canal. Therefore, since the acoustic coupling contains the information on the acoustical impedances, the ear canal transfer may be estimated based on the measured acoustic coupling. This may be done using any estimation method known in the art. It may for example be based on electro-acoustical models, statistic models, discrimination or decision tree based, neuronal networks, fuzzy logic, etc.

A second additional or alternative use is an estimate of the ear impedance. The ear impedance is a basis for hearing instrument optimization and for modeling in general. In principle, ear impedance measurement requires a laborious calibration of the system and measurement of the complex acoustic coupling transfer function. The corresponding 1-microphone theory has been published in EP 1 316 783. The content of this publication is incorporated herein by reference in its entirety.

A third additional or alternative use is an automatic on/off switch based on the measured acoustic coupling. This use is based on the insight that the acoustic coupling is characteristic of the situation where the hearing instrument is in place in or at the user's ear. As soon as the hearing instrument is removed, the acoustic coupling changes drastically, in which case the hearing instrument may switch off or switch to a standby-mode automatically. For this use, the acoustic coupling has to be measured repeatedly and permanently. This, however, does not imply the measurement to be real-time. A measurement once every split second, second, or plurality of seconds or even minutes may be sufficient.

As a fourth additional or alternative use, the acoustic coupling is used for making a diagnosis. This may be a diagnosis on the hearing instrument hard- or software or on the middle ear. For example, by means of characterizing the acoustic coupling, a clogging of the vent, the microphone or of the receiver outlet may be detected.

In accordance with a second aspect of the invention, the inner microphone of a hearing instrument according to the invention may also be used to measure other transfer functions than the transfer characteristic of the path from the digital signal to the acoustic signal in the ear canal.

A first example of such other characteristic is the “real ear occluded gain” transfer function. In addition to the signal provided by the hearing aid receiver(s), the user also perceives the acoustic signal bypassing the hearing instrument, through vent and guided by the human tissue, the instrument casing, etc. The output-input-relationship of this bypassing signal is called the real ear occluded gain (REOG). When the REOG is measured, the electro-acoustical amplification path of the hearing instrument is switched off, and the stimulating signal corresponds to the signal incident from outside, potentially supported by an additional source.

A second example of such other characteristic is the measurement of the acoustical feedback limit, i.e. the maximum achievable acoustical amplification for compensating the hearing loss. The acoustical feedback limit is not identical to the limit determined by the maximal DSP gain and standard RECD. It rather corresponds to the individual maximal acoustic gain. The acoustical feedback limit is not primarily dependent on the acoustic coupling, but depends on the path vent (+housing+tissue)—outcoupling—transfer to the outer microphone. This transfer is covered if the transfer from the inner microphone to the outer microphone is measured. Measurement of the acoustical feedback limit in accordance with this aspect of the invention, therefore, comprises supplying the receiver with a processor generated signal and comparing the sensing signal obtained by the inner microphone with the signal produced by at least one outer microphone upon incidence of the signal transmitted from the receiver back via vent, housing and human tissue.

The term “hearing instrument” or “hearing device”, as understood in this text, denotes on the one hand hearing aid devices that are therapeutic devices improving the hearing ability of individuals, primarily according to diagnostic results. Such hearing aid devices may be Behind-The-Ear (BTE) hearing aid devices or In-The-Ear (ITE) hearing aid devices (including the so called In-The-Canal (ITC) and Completely-In-The-Canal (CIC) hearing aid devices, as well as partially and fully implanted hearing aid devices). On the other hand, the term stands for devices which may improve the hearing of individuals with normal hearing, e.g. in specific acoustical situations as in a very noisy environment or in concert halls, or which may even be used in the context of remote communication or of audio listening, for instance as provided by headphones.

The hearing devices addressed by the present invention are so-called active hearing devices which comprise at the input side at least one acoustical to electrical converter, such as a microphone, at the output side at least one electrical to acoustical converter, such as a loudspeaker (often also termed “receiver”), and which further comprise a signal processing unit for processing signals according to the output signals of the acoustical to electrical converter and for generating output signals to the electrical input of the electrical to mechanical output converter. In general, the signal processing circuit may be an analog, digital or hybrid analog-digital circuit, and may be implemented with discrete electronic components, integrated circuits, or a combination of both. In the context of this application, signal processing units comprising digital signal processing means are preferred.

### BRIEF DESCRIPTION OF THE DRAWINGS

In the following, embodiments of the invention are described with reference to drawings. The drawings are all schematical and show:

FIG. 1 diagram of a hearing instrument according to the invention,

FIG. 2 an ear canal with an in-the-ear-canal component of a hearing instrument according to the invention,

FIG. 3 a diagram illustrating processing steps of a method according to the invention,

FIG. 4 a diagram illustrating the transfer steps of the acoustic coupling,

FIG. 5 graphs illustrating an example of a gain correction,

FIG. 6 a diagram illustrating processing steps of an alternative embodiment of the method according to the invention,

FIG. 7 a diagram illustrating the use of an A/D converter of a hearing instrument comprising multiple outer microphones,

FIG. 8 a diagram illustrating the measurement of the REOG,

FIG. 9 a diagram illustrating the measurement of the acoustic feedback limit,

FIG. 10 a diagram illustrating the estimation of the ear canal transfer function,

FIG. 11 a diagram illustrating further embodiments of the method according to the invention.

In the figures, corresponding components are provided with the same reference numerals.

### DESCRIPTION OF THE PREFERRED EMBODIMENTS

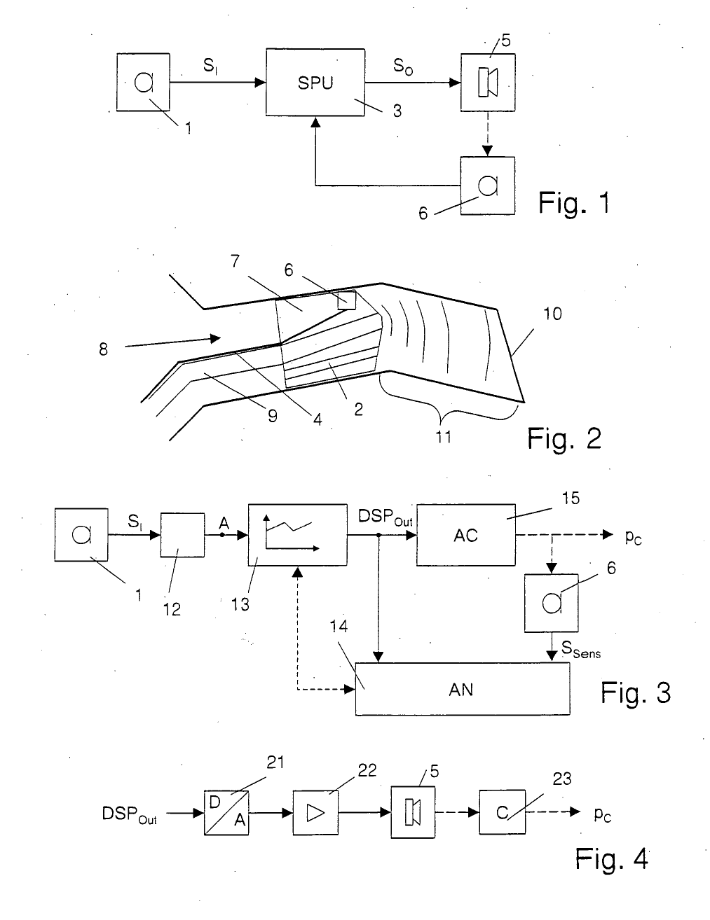

The hearing instrument of FIG. 1 comprises at least one outer acoustic-to-electric converter (microphone) 1 (often, two or even three acoustic-to-electric converters are available in each hearing instrument), a signal processing unit (SPU) 3 operable to apply a time- and/or frequency-dependent gain to the input signal or input signals S₁ resulting in an output signal S_{O} and at least one electric-to-acoustic converter (receiver) 5. The hearing instrument further comprises an inner acoustic-to-electric converter 6.

In FIG. 2, very schematically an ear canal 8 with an inserted in-the-ear-canal component, namely an otoplastic 7, of a behind-the-ear hearing instrument is illustrated. In general, an in-the-ear-canal component or an in-the-ear component of a hearing instrument in the context of this application is also called earpiece. The sound output signal is guided from the receiver to an interior of the ear canal 8 by means of a sound conducting tube 9 held by the otoplastic 7. The otoplastic 7 is an element shaped to fit in the user's ear, which comprises next to holding means for holding the sound conducting tube also a vent 2 for pressure equalization. The vent, and, more generally, the earpiece or the hearing instrument may have any shape as such know in the art including large vents (such as IROS venting), or limited open fittings (with or without otoplastics).

The inner microphone 6 is integrated in the otoplastic. In the figure, the eardrum is denoted by 10, the volume between the eardrum and the otoplastic by 11. In contrast to the shown embodiment, the inner microphone may be placed in an interior of the earpiece (or the CIC, ITC, or ITE hearing instrument) and may be connected to the volume 11 by a channel. It may also be arranged adjacent to the sound conduction means from the receiver to the volume or adjacent to the vent.

In the shown embodiment, a digital signal processor (a core part of the signal processing unit) and preferably the entire signal processing unit is placed in the behind-the-ear component (not shown), together with the outer microphone(s), the receiver, and a battery compartment. The hearing instrument comprises a sensing signal transmission wire 4 connecting the inner microphone with the signal processing unit. Signal transmission between the inner microphone and the signal processing unit may as an alternative be wireless, in which case, however, the in-the-ear-canal component has to comprise an energy source.

In the shown embodiment of a BTE hearing instrument, the inner microphone is placed in the earpiece, whereas the outer microphone and the receiver are arranged in the behind-the-ear component. Thus there is a sound conducting connection (sound conducting tube 9) between the receiver and the earpiece, and an electrical signal conducting connection between the inner microphone and the behind-the-ear-component. However, it is also possible to either place the inner microphone in the behind-the-ear component, in which case there is a sound conducting connection between the earpiece and the inner microphone, or to place at least one receiver in the earpiece (in which case there is an electrical signal conducting connection between the behind-the-ear component and the receiver), or both. It is even possible to place the outer microphone in the earpiece, although this alternative is clearly less preferred.

Instead of a behind-the-ear (BTE) hearing instrument, the instrument may also be an in-the-ear (ITE) or in-the-canal (ITC) hearing instrument, including a completely-in-the-canal (CIC) hearing instrument. In such a hearing instrument, the outer microphone(s) is/are for example placed on an outside facing side of the instrument, whereas the inner microphone is placed on the inside facing the eardrum or is connected to the inside by sound conducting means. In an ITE, an ITC or a CIC hearing instrument, the in-the-ear component is often the only constituent of the hearing instrument, i.e. the hearing instrument may consist of its in-the-ear-canal component. As yet another alternative, the in-the-ear component may be an in-the-ear-canal component of the kind described in the European patent application 05 405 022.4.

A very schematic diagram of the signal path in a basic embodiment of the invention is shown in FIG. 3. The outer microphone 1 produces an (analog) electric signal which is the input signal S₁ for the signal processing unit. The signal processing unit comprises a signal collecting stage 12. The signal collecting stage 12 preferably includes an analog-to-digital converter and may include further functionality such as analysis, the calculation of noise reduction parameters, etc. The signal processing unit further comprises a signal processing stage 13, where the input signal is transferred into a (digital) output signal. This may include having a frequency dependent gain act upon the signal, which frequency dependent gain may depend on parameters such as acoustic signal direction of incidence, signal level, detected noise levels, etc. Signal collecting stage 12 and signal processing stage 13 may together have the functionality of any known or yet to be developed signal management in hearing instrument technology.

The frequency dependent gain may, according to a preferred embodiment of the invention, be further dependent on a transfer characteristic, as will be explained in the following.

The output signal DSP_{Out} of the signal processing stage 13 is converted into an analog electric signal, amplified and converted into an acoustic signal. These steps are illustrated in FIG. 4, where 21 denotes a digital-to-analog converter, 22 an amplifier, 5 a receiver and 23 the sound conduction by tubing (if, for example, the hearing instrument is of the behind-the-ear-type) and the influence of the earmold (otoplastic).

Returning to FIG. 3, conversion of the DSP_{Out} signal into the real-ear acoustic signal in front of the eardrum is denoted by a single step “acoustic coupling” in the figure. As explained, for the purpose of the first aspect of the invention, it is sufficient to measure the acoustic coupling as a whole. Knowledge of the mechanisms underlying the individual steps—as represented in FIG. 4—is not necessary. Note that in the representation of FIG. 3, as well as in the following description, the acoustic coupling 15 includes the digital-to-analog conversion and the amplification by the analog amplifier. The term “acoustic coupling”, therefore, in this description is used for the sum of steps leading to the conversion of the processed digital output signal into the real-ear acoustic signal in the ear canal.

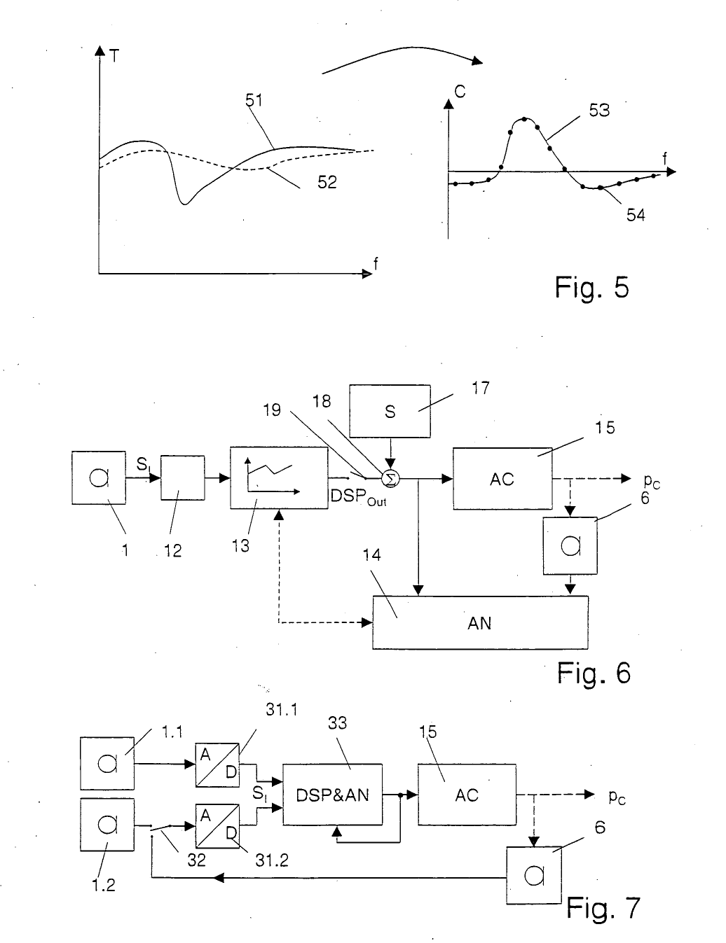

The ear canal sound pressure level p_{C} in the volume 11 in front of the eardrum is sensed by the inner microphone 6. The sensing signal Sₛₑₙₛ output by the inner microphone 6 is compared to a signal DSP_{Out} representative of the receiver input by an analyzer 14. The transfer characteristic may for example be represented by explicitly known parameters of a transfer function T(ƒ) or as an alternative by appropriate gain correction values, etc. The transfer characteristic is supplied to the signal processing stage and preferably has an influence on the effective gain values. The DSP may control the analyzer 14; it may for example trigger a measurement, define the measurement parameter, etc. For example, if the transfer characteristic reveals that the acoustic signal in a particular frequency region is suppressed stronger than average, the gain calculated by the signal processing unit based on the input signal and pre-stored information is corrected by a corresponding increase in said frequency region. A simplified example of an evaluation of a gain correction C(ƒ) is very schematically shown in FIG. 5. The acoustic coupling transfer function T(ƒ) of a signal 51 is compared with an average transfer function 52 which may have been obtained as an average of a large number of measurements or by a measurement with a 2 cc coupler, which is factory stored in the signal processing unit and to which the uncorrected gain calculation is adapted. From the difference of the signal 51 and the average signal 52, a gain correction C(ƒ) is evaluated. The gain correction may be stored in the signal processing unit and be applied to the gains evaluated thereby during operation of the hearing instrument. Since the acoustic coupling is linear and the acoustic coupling transfer function essentially time and acoustic signal independent, so is the gain correction. Therefore, applying the once evaluated gain correction C to the input signal a plurality of times always results in an appropriately corrected gain. The dots 54 in the right panel of FIG. 5 illustrate a discretized version of the gain correction for the case the gain is evaluated discretely in a number of frequency bands. Applying the gain correction may then just be an addition of the correction values C_{ƒ} to the calculated gain values. The correction values C_{ƒ} are indicative of the transfer characteristic, and storing a number of discrete gain correction values C_{ƒ} is also a preferred way of storing the characteristic in the signal processing unit.

According to a further, less preferred embodiment, instead of a signal representative of the receiver input, a signal of a different stage in the signal processing may be used, for example an input signal of the signal processing stage 13 (tapped at point A in the figure).

As mentioned, it has been found that the acoustic coupling is approximately linear and that it therefore may be viewed as independent of the sound level and as a consequence also independent of the operations of the signal collecting stage 12 and of the signal processing stage 13. This means that the acoustic coupling may be characterized by a transfer function T(ƒ): Sₛₑₙₛ(t,ƒ)=T(ƒ)DSPₒᵤₜ(t,ƒ), where ƒ denotes the frequency and t the time. Therefore, the analyzer can characterize the acoustic coupling once (or repeatedly with a repetition rate that is small compared to the sampling rate of the digital signal processor, for example during the fitting process and once every hour, or once every day), and the characterization parameters—for example parameters of a transfer function—may be stored. The characteristic may in the following be used for setting an appropriate, situation adapted gain or the like.

FIG. 6 shows an alternative embodiment of a hearing instrument. The illustrated hearing instrument is distinct from the hearing instrument of FIG. 3 in that it comprises a signal generator 17 for generating a measuring signal in order to potentially enhance the quality of the measurement. The measuring signal may be admixed to the processed input signal, or it may be used instead of the latter. The corresponding adding stage 18 and switch 19 are also illustrated in the figure.

The hearing instrument of FIG. 7 is of the type comprising at least two outer microphones in order to enable beamforming. Each outer microphone is allocated an Analog-to-Digital converter 31.1, 31.2 (which may be integrated in a signal processing unit and which is comprised in the signal collecting stage 12 in the above figures; if the A/D converters are not integrated, instead of two separate A/D converters, in practice often a dual A/D converter comprising two inputs and two outputs will be used). Also the inner microphone output signal, of course, has to be analog-to-digital-converted in the case of digital signal processing. Corresponding analog-to-digital converters are not shown separately in FIGS. 3 and 6, but are assumed to be integrated in the analyzer 14. However, due to the approach in accordance with the invention, the inner microphone 6 output signal does not permanently need to be processed and as a consequence does not permanently require an analog-to-digital converter. The hearing instrument of FIG. 7 comprises a switch 32 by which alternatively the output of one outer microphone 1.2 and of the inner microphone 6 may be connected to the input of one of the A/D converters. This makes possible, that for occasional measurements of the transfer characteristic, beamforming functionality is at least partially interrupted (if the hearing instrument is not anyway in the “omni” mode in which only one microphone signal is required), and the characteristic may be measured without interrupting the hearing aid operation and with the switch 32 as only additional hardware. In the representation of FIG. 7, the functionality of the analyzer is shown as integrated in the digital signal processor 33.

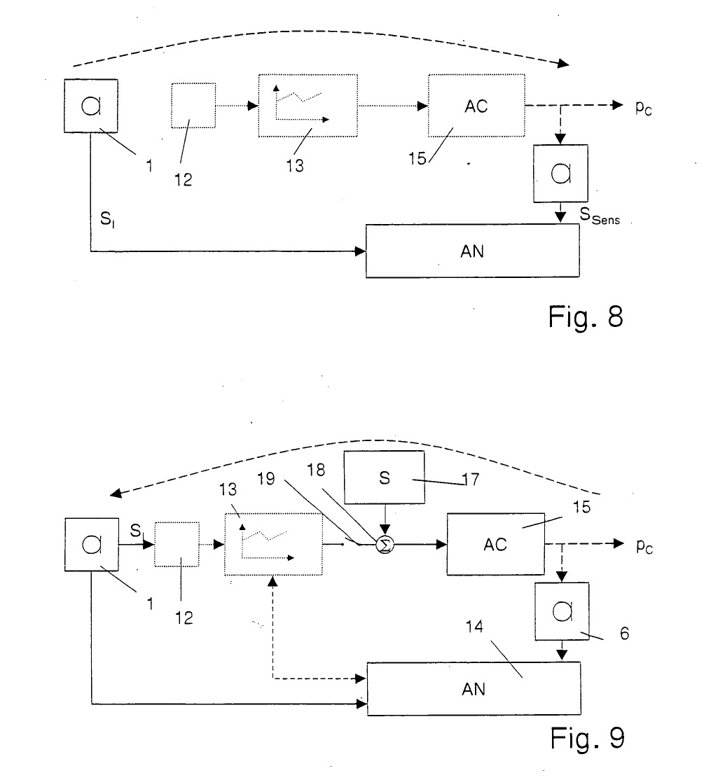

FIGS. 8-11 illustrate different operation modes of the hearing instrument of either of the hearing instruments sketched in the previous Figures. In accordance with FIG. 8, a real ear occluded gain (REOG) characteristic is measured. For this measurement, the amplification path of the hearing instrument is switched off, and merely the output signals of the outer microphone 1 and of the inner microphone 6 are compared to provide a REOG transfer characteristic. This may be by way of a REOG transfer function T_{REOG}(ƒ), where for example S_{SENS}(ƒ,t)=T_{REOG}(ƒ)*S_{I}(ƒ,t).

A set-up for measuring the real-ear acoustical feedback limit is shown in FIG. 9. A measuring signal generated by the signal generator 17 is output via the receiver, preferably in a situation, where no or little external noise is present. The analyzer compares the sensing signal S_{Sens} by the inner microphone with the signal S_{I} detected by the outer microphone. From this comparison, the analyzer can compute the individual maximum gain which information is used by the signal processing stage 13 in subsequent signal processing.

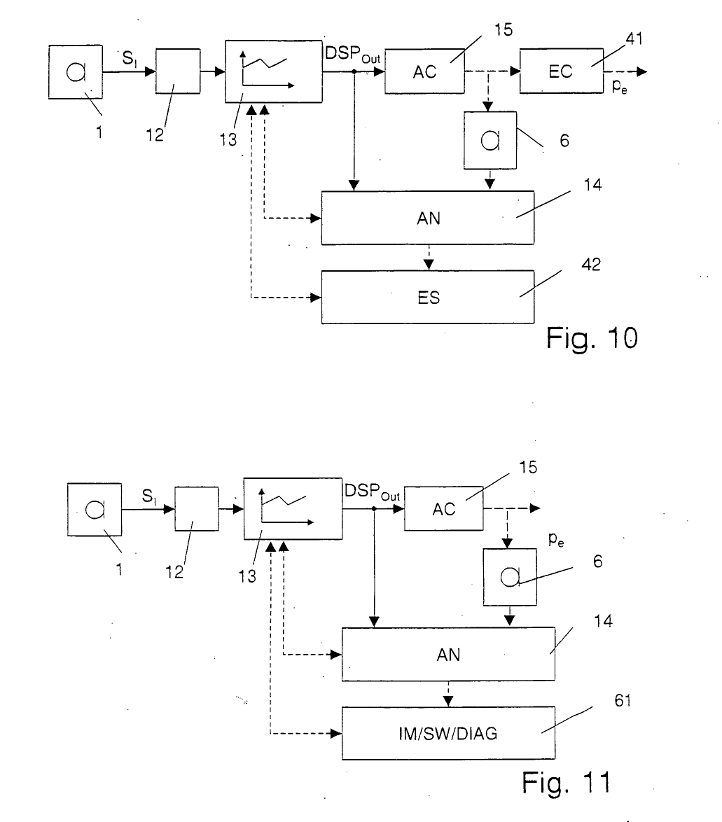

FIG. 10 illustrates the estimation of the ear canal transfer characteristic. By this estimation, the difference between the real-ear sound level at the place of the inner microphone and at the position of the eardrum is addressed. The ear canal transfer 41 is illustrated by a corresponding box in the figure. The ear canal transfer characteristic estimator 42 is provided with appropriate means of estimating the ear canal transfer characteristic from the acoustic coupling transfer characteristic.

Further uses of the knowledge of the acoustic coupling transfer characteristic are summarized in FIG. 11. According to one embodiment, the additional processing stage 61 serves for calculating or estimating the ear impedance (IM). According to another embodiment, the additional processing stage 61 determines whether or not the hearing instrument is properly worn by the user. This allows the hearing instrument to control a corresponding smart on/off-switch by which for example the consumption of electricity may be drastically reduced in case the hearing instrument is not worn. According to yet another embodiment, the further processing stage calculates a quantity (DIAG) which may be used for diagnosing a status of either the person wearing the hearing instrument or the hearing instrument itself or both. The uses of FIGS. 10 and 11 may, of course, be combined.

What is claimed is:

1. A method of obtaining a characteristic of acoustical circumstances in an ear canal of a user, in which a hearing instrument or a hearing instrument component is placed, the hearing instrument including at least one outer microphone, a signal processing unit, at least one receiver, and at least one inner microphone operable to obtain a sensing signal from an acoustic signal at a position in front of the user's eardrum, the method comprising the steps of producing an acoustic signal in at least a part of the ear canal, of obtaining, by means of said inner microphone, a sensing signal representative of said acoustic signal, of determining, by said signal processing unit and from said sensing signal, a characteristic of the acoustical circumstances, and of memorizing values indicative of said characteristic for further use.

2. A method according to claim 1, wherein said acoustic signal is produced by said at least one receiver, and wherein said characteristic is a transfer characteristic.

3. A method according to claim 2, wherein the acoustic signal is directed from the receiver to the ear canal by means of a sound conducting tube positioned at least partially in the ear canal.

4. A method according to claim 2, wherein a signal obtained from the at least one outer microphone is processed into an output signal, and wherein processing of said signal obtained from the at least one outer microphone into an output signal includes a digital signal processing stage, and wherein for determining the transfer characteristic, a signal representative of an output of said digital signal processing stage is compared to said sensing signal.

5. A method according to claim 4, comprising the further step of adjusting a gain acting on an input signal of the signal processing unit based on the transfer characteristic.

6. A method according to claim 2, wherein said transfer characteristic is given by a transfer function, and wherein said values are parameters of the transfer function.

7. A method according to claim 2, wherein a receiver input signal is supplied by a processor generated measuring signal for generating said acoustic signal.

8. A method according to claim 2, comprising the further step of adjusting a gain acting on an input signal of the signal processing unit based on the transfer characteristic.

9. A method according to claim 2, wherein the transfer characteristic is used to estimate an ear canal transfer function indicative of an acoustic transfer property within the ear canal to the eardrum.

10. A method according to claim 2, wherein the transfer characteristic is used to estimate an ear impedance.

11. A method according to claim 2, wherein the transfer characteristic is used to determine whether the hearing instrument is properly worn by the user, and wherein the hearing instrument is switched off or is switched to a standby mode if it is found not to be worn by the user.

12. A method according to claim 2, wherein the transfer characteristic is used to make a diagnosis on a state of the hearing instrument or on a status of the user.

13. A method according to claim 1, wherein the transfer characteristic is obtained at least one of:
(i) upon a user induced event, and of
(ii) repeatedly at regular or irregular intervals during operation of the hearing instrument, wherein said intervals are greater than a signal processing unit sampling interval by at least a factor of 1000.

14. A method according to claim 1, wherein the acoustic signal is produced by an acoustic source outside of the ear canal, wherein, for the determination of the sensing signal, any amplification by the hearing instrument is switched off, and wherein the characteristic is a real ear occluded gain transfer characteristic.

15. A method according to claim 1, wherein the input of the at least one receiver is supplied by a processor generated measuring signal for generating said acoustic signal, and wherein said characteristic is an acoustical feedback limit measured by comparing the sensing signal with an acoustic signal detected by at least one outer microphone.

16. A hearing instrument comprising an in-the-ear component adapted to be at least partially placed in the ear canal of a user, the hearing instrument further comprising at least one outer microphone, a signal processing unit comprising a data memory, and at least one receiver, the signal processing unit being operable to transform an input signal provided by said at least one outer microphone into an output signal supplied to said at least one receiver, the hearing instrument further comprising at least one inner microphone operable to obtain a sensing signal from an acoustic signal at a position in front of the user's eardrum, an output of the inner microphone being operatively connected to an input of the signal processing unit, the signal processing unit being operable to obtain from the sensing signal provided by said inner microphone, a characteristic of acoustical circumstances in the user's ear canal, and to memorize, in said data memory, values indicative of said characteristic for further use.

17. A hearing instrument according to claim 16, the output of the inner microphone not being part of a control loop.

18. A hearing instrument according to claim 16, wherein the signal processing unit comprises a digital signal processing component and an analyzer entity, the analyzer entity operable to carry out a comparison between said sensing signal and a an output of said digital signal processing component, to evaluate said characteristic from said comparison, and to provide said characteristic to the digital signal processing component.

19. A hearing instrument according to claim 16, wherein the signal processing unit comprises a signal generator operable to generate a processor generated measuring signal supplied to said at least one receiver.

20. A hearing instrument according to claim 16, the in-the-ear component comprising a vent.

21. A hearing instrument according to claim 20, the in-the-ear component being an open fitting element.

22. A hearing instrument according to claim 16 being a behind-the-ear hearing instrument comprising a behind-the-ear component, the behind-the-ear component including a digital signal processor of the signal processing unit, the in-the-ear component being an earpiece connected to the behind-the-ear component by sound conduction means and further by signal transmission means operable to transmit the sensing signal to the digital signal processor.

23. A hearing instrument according to claim 22, wherein the inner microphone is placed in the earpiece, and wherein the hearing instrument comprises an electrical wiring between the inner microphone and the digital signal processor.

24. A hearing instrument according to claim 22, wherein the inner microphone is placed in the behind-the-ear component and wherein the hearing instrument comprises a sound conduction tubing between a position fixed by the earpiece and the inner microphone.

25. A hearing instrument according to claim 23, wherein the receiver or all receivers are placed in the behind-the-ear component, and wherein the hearing instrument comprises a sound conduction tubing between the receiver and a position fixed by the earpiece.

26. A hearing instrument according to claim 24, wherein the receiver or all receivers are placed in the behind-the-ear component, and wherein the hearing instrument comprises a sound conduction tubing between the receiver and a position fixed by the earpiece.

27. A hearing instrument according to claim 22, wherein at least one receiver is arranged in the earpiece, and wherein the hearing instrument comprises an electrical wiring between the signal processing unit and the receiver.

28. A hearing instrument according to claim 16 being an in-the-ear, in-the-canal or completely-in-the-canal hearing instrument.

29. A hearing instrument comprising
at least one acoustic signal acquisition microphone,
a signal processing unit,
and at least one receiver, the at least one acoustical signal acquisition microphone being operationally connected to a first input of the signal processing unit,
an output of the signal processing unit being operationally connected to an input of said receiver,
the signal processing unit comprising a digital signal processing stage and a memory,
an output of said digital signal processing stage being operationally connected to said output of the signal processing unit,
the hearing instrument further comprising an in-the-ear canal acoustic signal acquisition microphone, an output of which is operationally connected to a second input of said signal processing unit,
the signal processing unit being operable to apply a gain on an input signal supplied to said first input to obtain an output signal and to supply said output signal to said output,
the signal processing unit further being operable to calculate, based on a comparison of said sensing signal supplied to said second input with an output signal of said digital signal processing stage, a transfer characteristic, and to apply a gain adjustment on said gain, the gain adjustment based on said transfer characteristic,
wherein at least one of the transfer characteristic and of the gain adjustment is stored in the memory, and wherein the same transfer characteristic is used for determining a gain adjustment for a plurality of gain calculation cycles or wherein the same gain adjustment is applied to the gain for a plurality of gain calculation cycles.

30. A method of manufacturing a hearing instrument, the method comprising the steps of
assembling at least one outer microphone, a signal processing unit, at least one receiver and at least one inner microphone, the inner microphone forming part of an in-the-ear component or comprising sound conducting tubing connecting it to the in-the-ear component, the signal processing unit comprising a data memory,
of establishing operational connections between an output of the at least one outer microphone and the signal processing unit, between an output of the signal processing unit and an input of the at least one receiver, and between an output of the at least one inner microphone and a further input of the signal processing unit,
and of providing the signal processing unit with a software enabling the signal processing unit to obtain from a sensing signal provided by said inner microphone, a characteristic of acoustical circumstances in the user's ear canal, and to memorize, in the data memory, values indicative of said characteristic for further use.
